(19) United States
(12) Patent Application Publication
(10) Pub. No.: US 2011/0041294 A1
(43) Pub. Date: Feb. 24, 2011

(54) RELEASABLE MAGNETIC FASTENING SYSTEM

(76) Inventors: Evan Ehring, Maple Valley, WA (US); Carolyn Anderson, Maple Valley, WA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 12/546,362

(22) Filed: Aug. 24, 2009

(51) Int. Cl. A44B 21/00; B32B 3/06

(52) U.S. Cl. 24/303; 428/99

(57) ABSTRACT

A magnetic engagement and fastening system for joining components, which offers true slip resistance in all degrees of freedom, particularly in a horizontal direction parallel to the general plane of the fasteners, in combination with ease and quietness of disengagement of the joined components. The system employs the principles of magnetic attraction to restrict motion in the horizontal plane. Two units, at least one with raised magnetic members and the other with at least mating magnetically attractable recesses or hollow areas are provided.

### FIELD OF INVENTION

This invention relates generally to a releasable fastening system and more particularly, to a slip resistant magnetic fastening system.

### BACKGROUND OF THE INVENTION

In the art of fastening systems, magnetic fastening systems are a relatively recent innovation. Magnetic fasteners offer the prospects of a relatively strong fastener but can be released quietly, without the “tearing” noise generally associated with a zipper or a traditional hook/loop fastener system. Quiet engagement and release is particularly important in some applications such as law enforcement or wartime applications. In one design, a magnetic fastening system uses the hook and loop terminology and technology, but allows for various shapes in the hook design as is known in the art. Magnetorheological elastomer of hooks and loops are also known in the art. Electrostatic charges are used in a magnetic hook and loop system. Although these design hold well together and resist being “torn apart”, these designs do, however, all suffer from one major fault which is that they tend to slip or come apart when the two pieces are slid in the horizontal direction. In addition, they are bulky (having a very large profile) have a complex design and are difficult and complicated to manufacture (the hook and loops are very intricate and require specialized machines) and while not as loud as traditional “hook & loop” fasteners when separated, they still create a noise signature. Due to the relatively recent development of magnetic fastening systems, different approaches to magnetic properties have been explored, but there remains a need for a sturdy yet easily releasable fastening system that is quiet when released and that resists horizontal slippage.

### SUMMARY OF THE INVENTION

The structure of the magnetic fastening system of the present invention is unique, as it provides a secure fastener while being easily releasable. An aspect of the present invention is the absence of a “hook and loop” or “hook and hook” system. In its place, interconnecting magnetic members are utilized. An advantage of the instant design is illustrated in the slip resistance offered in all directions, particularly in the horizontal plane of engagement. An object of the present invention is a releasable fastening system having resistance to pull along the horizontal plane. Another object of the present invention is generally silent attachment and detachment of the magnetic fastening members.

It is therefore an object of the present invention to provide a slip resistant, engagement and fastening system. It is additionally an object of the present invention to provide fastening system, flexible enough to be utilized for many applications.

It is a further object of the present invention to provide a fastening system, which combines magnetic attraction and interlocking members in order to restrain motion of engaging members in numerous degrees of freedom. It is an object of the instant invention to provide a system, which can be permanently affixed or releasably attached to the engaging surfaces of opposing members to be affixed.

Advantages of the instant design include the flexibility a designer has when deciding the shapes of the magnetic units to be used in a given system, as well as the strength of the magnets and the shapes of the interconnecting magnetic members. While the combination yields an engagement system including substantially comprehensive slip resistance in all directions. The use of magnetic attraction ensures that the instant releasable fastening system operates with virtually no sound emitted when the system is released or engaged.

These and other objects are achieved in accordance with the invention by providing a fastening system or device, which includes opposing, mating members. These and other features, aspects and advantages of the present invention will become better understood with reference to the following description and accompanying drawings. Therefore the form of the invention as set out above should be considered illustrative and not as limiting the scope of any allowed claims and their legal equivalents.

It is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. It is important to note that the present invention is not intended to be limited to a device or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and their legal equivalents.

### BRIEF DESCRIPTION OF THE DRAWINGS

These and other features and advantages of the present invention will be better understood by reading the following detailed description, taken together with the drawings wherein:

FIG. 1 is a plan view of a first unit of a releasable magnetic fastening system according to one embodiment of the present invention, which contains magnetic dots;

FIG. 2 is a plan view of a second unit of the releasable magnetic fastening system which is designed to mate with the first unit shown in FIG. 1 according to one aspect of the present invention;

FIG. 3 is a cross-sectional view of one unit of the releasable magnetic fastening system taken along lines 3-3 shown in FIG. 1;

FIG. 4 is a side view of the releasable magnetic fastening system taken along lines 4-4 of FIG. 2;

FIG. 5 is an isometric plan view of the two units of the releasable magnetic fastening system according to the present invention, showing the two units in a partially engaged position;

FIG. 6 is a plan view of one unit of the releasable magnetic fastening system according to the present invention, this view shows magnetic dots arranged in 3×3 grids;

FIG. 6A is a plan view of a second unit of the releasable magnetic fastening system according to the present invention, this view shows 3×3 grids that can interlock with the unit shown in FIG. 6;

FIG. 7 is a cross-sectional view of the unit of the releasable magnetic fastening system taken along lines 7-7 of FIG. 6;

FIG. 8 is cross-sectional view of the unit of the releasable magnetic fastening system taken along lines 8-8 of FIG. 6;

FIG. 9 is a cross-sectional view of two mating releasable magnetic fastening system units according to the present invention;

FIG. 10 is a plan view of one unit of the releasable magnetic fastening system according to one embodiment of the present invention; and

FIG. 11 is a side view of two units of releasable magnetic fastening system in near mating position taken along lines 1 1-11 of FIG. 10 according to one aspect of the present invention.

### DETAILED DESCRIPTION OF THE PREFERRED EMBODIMENTS

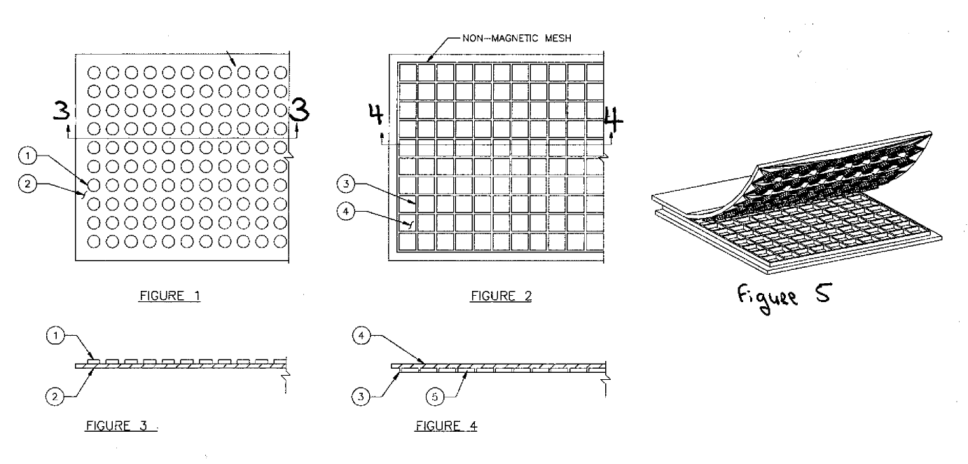

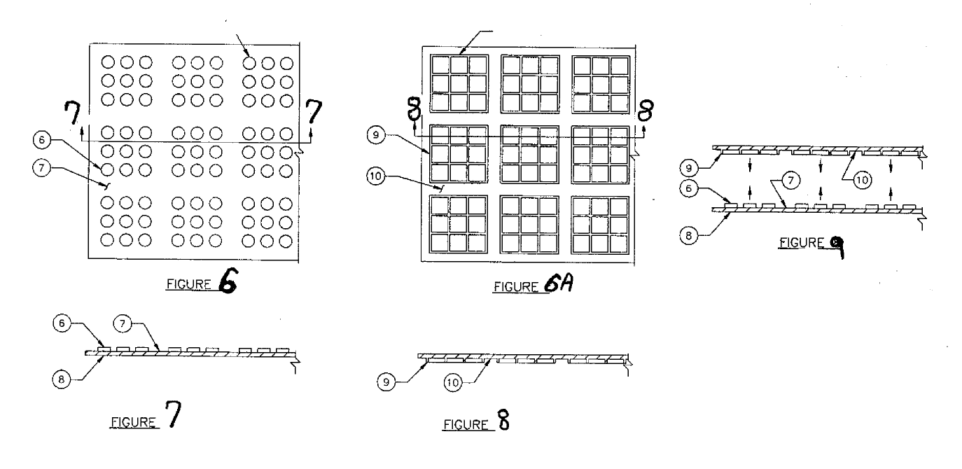

A first embodiment of the present invention is illustrated generally in FIGS. 1, 2, 3, 4 and 5. Illustrated herein, a novel combination of opposing and mating magnetic and/or magnetically attractable apparatuses designed to operate as engaging or mating couples, at least one of which includes raised members, infused with or made from magnetic material. The raised members, provided in one embodiment as circularly disposed dots 1, of magnetic material, such as a magnetic polymer having a minimum release point of approximately 8 lb per square foot of material, protruding from a first flat magnetic or non-magnetic sheeting 2 comprising one unit of the releasable magnetic fastening system. The protrusions of the raised dots 1 from the flat magnetic sheeting 2 is shown more clearly in FIG. 3. An interlocking grid formation 3, FIG. 2, protruding from a second flat magnetic sheeting 4 comprises the other mating unit of the releasable magnetic fastening system. The protrusion of the grid formation 3 from the magnetic sheeting 4 is better depicted in FIG. 4. The space or region 5 for engagement of the raised magnetic dots 3 is also shown in FIG. 4. The space or region 5 for engagement of the raised magnetic dots 3 may also have a minimum release point of approximately 8 lb per square foot of material. The fact that the raised elements 1 (illustrated for exemplary purposes only as dots but which could be squares of other shapes) in the first unit of the system engage with the space or region 5 in the second unit of the system (as shown in FIG. 5) prevents one unit from “slipping” or “sliding” in any direction across the horizontal plane; allowing the units to only be “pulled” apart.

A second modified embodiment of the present invention is illustrated in FIGS. 6, 6A, 7, 8 and 9. In this second embodiment, the same raised magnetic dots may be utilized, however, herein, the raised protrusions and mating receiving regions instead of being generally uniformly distributed on the underlying sheeting may be arranged in groups or clusters 6 with a defined space 7 between the dot clusters 6 to allow for the sheet of material to be cut into squares or a “tape” and affixing of the square or tape to a surface, either temporarily or permanently, by such methods as stapling, sewing, stitching, gluing, riveting or by any method known in the art. This is demonstrated in FIG. 6 with a side view showing the magnetic dot clusters 6, the open area or space 7 between the dot clusters 6 for potential stitching and the protrusion of the dots from the magnetic sheeting or sheet member 8. It should be noted that while the mating dots of the present invention are shown in regular, linear arrays, mating with regular, grids, the present invention can be practiced with any configuration of raised magnetic members, mating with magnetic recesses.

FIG. 6A illustrates a mating mesh side of the releasable magnetic fastening system arranged in order to allow the mating sides of magnetic tape to engage such that the mating of the magnetic dot clusters 6 with the magnetic sheet members 10 of the interlocking grids 9 thereby preventing slippage of the releasable magnetic fastening system in a horizontal direction.

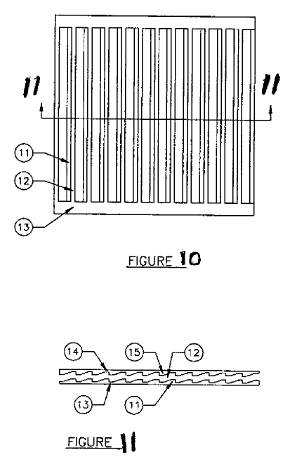

The protrusion of the interlocking grid 9 from a second magnetic sheet member 10 is shown in cross-sectional view, along axis 8-8 in FIG. 8.

FIG. 9 illustrates two mating sides of engaging magnetic releasable magnetic fastening system being brought into mating position. Magnetic dot clusters 6, protrude from a magnetic sheet member 8, and are spaced to fit inside the interlocking grid 9, which protrudes from the second magnetic sheet member 10. The open space 7 between the dot clusters 6 is still capable of achieving contact with the interlocking grid, though no raised dots are present and this will not change the function of the releasable magnetic fastening system. It should be noted that while the dots are shown in regular, square clusters, any formation of mating clusters of magnetic dots are within the scope of the present invention. Further, the raised protrusions and mating receiving regions need not be circular but may take the form of any other shape.

FIG. 10 illustrates yet another embodiment of the present invention. In this embodiment, magnetic protrusions 11 and oppositely charged and mating magnetic grooves 12 are both disposed upon each magnetic sheet member 13.The open spaces in the grooves 12 may be used for attaching the magnetic tape or sheet to another surface.

FIG. 11 is a cross-sectional view of the releasable magnetic fastening system taken along lines 11-11 as illustrated in FIG. 10. This interlocking is shown with the first magnetic sheet member 13 and protrusions 11 of one side fitting in tightly with a second magnetic sheeting 14 and opposing grooves 15 of the other side by reversing one sheet from the other since both sheets are identical and have the same undulating pattern. It should be noted that while configurations of groves and spaces is shown to be linear, the present invention is not limited to linear arrangements. Zig-zags, curves or random mating protrusions and mating grooves are all within the scope of the present invention. In addition, the arrangement and angle of the magnetic protrusions and grooves may be arranged, as needed, to provide the requisite holding strength in a particular direction. For example, when there is a need for substantial strength holding a tab in a pocket or container or ouch in which a heavy object will be carried, the protrusions can be slanted to one side or direction and grooves in a corresponding mating shape so that the magnetic force and gravity will slide the pieces into place and hold in place against one another. This would provide more resistance than in the circular dot configuration.

Addressing material considerations, the numerous designs illustrated herein, as well as complimentary additional embodiments, possess such an adaptable nature as to be configured or manufactured from numerous materials, including, but not limited to polymers, metals and composites. Due to the simplistic shapes involved, when utilizing polymers, varied forms of manufacture may be utilized including extruding, rolling, molding or stamping. Once again, due to the uniformity and simplicity of the shapes, standard metal forming methods may also be utilized.

Moreover, the form and strength of the magnetic material employed can vary depending upon the design and application thereof. Magnetic materials can be embedded in the form of magnetic members or interspersed throughout the material of choice during formation. The shape of magnetic materials may also be varied depending on the application. The strength of the mating magnetic members may vary within a single releasable magnetic fastening system, i.e. weaker magnetic dots may be disposed on the edges of a tape to facilitate detachment, along with stronger central dots used to strengthen the member-to-member attachment.

Other and further objects, aims, purposes, features, advantages, embodiments, usages and the like will be apparent to those skilled in the art from the present specification taken with the accompanying drawings and the allowed claims.

These together with other objects of the invention, along with the various features of novelty, which characterize the invention, are pointed out with particularity in the features annexed to and forming a part of this disclosure. The invention is not limited to the embodiments described herein, thus reference should be made to the accompanying drawings and descriptive matter in which the preferred embodiments of the invention are illustrated. Modifications and substitutions by one of ordinary skill in the art are considered to be within the scope of the present invention, which is not to be limited except by the allowed claims and their legal equivalents.

What is claimed is:

1. A releasable fastening system, comprising:
a first unit comprising a sheeting having a generally planar upper and lower surface, wherein at least one surface comprises a plurality of substantially raised members disposed on at least one side of said first unit, said raised members raised a sufficient amount to fasten securely to a second unit, at least said substantially raised members comprising a magnetic material; and
a second unit comprising a sheeting having a generally planar upper and lower surface, wherein at least one surface comprises a plurality of recessed areas, at least said recessed areas magnetically attractable and configured for mating with said substantially raised magnetic members of said first unit, whereby said mating of said substantially raised magnetic members of said first unit with said a plurality of magnetically attractable recessed areas provides slip resistance at least in a direction parallel to said planar first and second units.

2. The fastening system of claim 1, wherein said substantially raised magnetic members comprise a substantially circular shape.

3. The fastening system of claim 1, wherein said substantially raised magnetic members comprise a substantially rectangular shape.

4. The fastening system of claim 1, wherein at least one surface of said sheeting of said second unit further comprises at least one substantially raised interlocking grid forming a plurality of recesses configured to receive said substantially raised members of said first unit.

5. The fastening system of claim 4, wherein said at least one interlocking grid is of a square shape.

6. The fastening system of claim 1 wherein said plurality of substantially raised members are arranged in clusters that allow said system to achieve a desired magnitude of slip resistance.

7. The fastening system of claim 6 wherein a sufficient space exists between said clusters of raised dots to allow said first unit to be attached to another surface using said space.

8. The fastening system of claim 1, wherein said first unit further comprises a plurality of substantially raised members disposed generally uniformly on one side of said first unit.

9. The fastening system of claim 4, wherein both sides of said magnetic sheeting of said second unit comprises at least one substantially raised interlocking grid disposed to receive said substantially raised members.

10. A method for operating a releasable fastener system, the method comprising:
providing a first unit comprising a magnetic sheeting having a plurality of raised members on a single side of said first unit;
providing a second unit comprising a magnetic sheeting wherein at least one portion of second unit comprises a plurality of raised regions forming recesses between adjacent said raised regions, and disposed on a single side of said second unit; and,
releasably engaging said first unit with said second unit such that at least some of said plurality of raised members disposed on said first sheet are disposed in said recesses between said raised regions on said second sheet in order to maintain slip resistance between said first and second units in both the horizontal and vertical planes.

11. The method of claim 10 wherein said raised members comprise magnetic members.

12. The method of claim 10 wherein said raised members are of a substantially circular shape.

13. The method of claim 10 wherein said plurality of raised members on a single side of said first unit covers generally said entire single side of said first unit.

14. The method of claim 10 wherein said raised regions disposed on a portion of a single side of said second unit covers generally said entire second unit.

15. The method of claim 10 wherein said raised magnetic members are disposed in separated clusters to improve the fastening capability of said first and second sides.

16. The method of claim 14 wherein said raised magnetic members disposed in separated clusters are sufficiently spaced apart to allow for attaching said opposite said side containing said dots of said first unit to another surface.

17. The fastening system of claim 1 wherein said first unit comprises a sheet comprising a plurality of longitudinal raised ridges, each longitudinal raised ridge followed immediately by longitudinal recess or groove disposed on a single side of said first unit, said first unit having a longitudinal raised ridge proximate one edge and a longitudinal recess proximate an opposite edge, and wherein said plurality of longitudinal raised ridges are of a magnetic material and said longitudinal recesses are comprised of a magnetically attractable material, and wherein said second unit comprises a sheet comprising a plurality of longitudinal raised ridges, each longitudinal raised ridge followed immediately by longitudinal recess or groove disposed on a single side of said second unit, said second unit having a longitudinal raised ridge proximate one edge and a longitudinal recess proximate an opposite edge, and wherein said longitudinal raised ridge is of magnetic material and said longitudinal recess is of a magnetically attractable material, and wherein said first and second units are configured for mating attachment by engaging one or more longitudinal ridge from one unit with one or more longitudinal recess from the other unit.

18. A releasable fastening system, comprising:
a first unit comprising a sheet comprising a plurality of magnetic longitudinal raised ridges followed immediately by longitudinal recesses or grooves disposed on a single side of said first unit, said first sheet having a longitudinal raised ridge proximate one edge and a longitudinal recess proximate an opposite edge and wherein said longitudinal raised ridge is of magnetic material and said longitudinal recess is of a magnetically attractable material; and
a second unit comprising sheet comprising a plurality of longitudinal raised ridges followed immediately by longitudinal recesses or grooves disposed on a single side of said first unit, said second unit having a longitudinal raised ridge proximate one edge and a longitudinal recess proximate an opposite edge, and wherein each said longitudinal raised ridge is of magnetic material and each said longitudinal recess is of a magnetically attractable material, and wherein said first and second units are configured for mating attachment by engaging one or more longitudinal ridge from one unit with one or more longitudinal recess from the other unit.
